(19) United States
(12) Patent Application Publication
(10) Pub. No.: US 2008/0243417 A1
(43) Pub. Date: Oct. 2, 2008

(54) Magnetometer normalization

(75) Inventors: Mamdouh Yanni, Markham (CA); Alexei Gavriline, Toronto (CA); Ming He, Markham (CA); Warren Tom, Toronto (CA); Joseph Schembri, Richmond Hill (CA)

Correspondence Address: CARR & FERRELL LLP, 2200 GENG ROAD, PALO ALTO, CA, 94303, US

(73) Assignee: Destinator Technologies, Inc.

(21) Appl. No.: 11/824,234

(22) Filed: Jun. 29, 2007

Related U.S. Application Data
(60) Provisional application No. 60/920,241, filed on Mar. 26, 2007.

(51) Int. Cl. G01C 25/00

(52) U.S. Cl. 702/95

(57) ABSTRACT

Systems and methods for correcting received magnetometer coordinates of a measured magnetic bearing are disclosed. The measured magnetic bearing may be received from a calibrated magnetometer configured to measure the strength and direction of a magnetic field. In embodiments used to navigate a geographical area, the magnetic field comprises, at least in part, Earth's magnetic field. The magnetic field is subject to anomalies caused by metal structures in the vicinity of the magnetometer. The corrected magnetic bearing is based on a slope of the coordinates relative to a defined origin and a magnetic field constant, such as Earth's magnetic field constant. In some embodiments, the received magnetometer coordinates are filtered prior to correction. In some embodiments, a magnitude of the measured magnetic bearing relative to the defined origin is compared to an anomaly detection limit and a bearing validity indicator is output according to the result of the comparison.

### CROSS-REFERENCES

This U.S. nonprovisional patent application claims priority to and the benefit of U.S. provisional patent application No. 60/920,241 filed Mar. 26, 2007 and entitled “Continuous Navigation System” which is hereby incorporated by reference herein.

### BACKGROUND

1. Field of the Invention

The present invention is generally related to directional navigation and more specifically to correction of a magnetic bearing measured by a magnetometer.

2. Related Art

To navigate within a geographical area, various technologies may be used including a Global Positioning System (GPS), accelerometers, and/or magnetometers. A magnetometer is an electronic tool that measures the strength and/or direction of a magnetic field. In navigation, the Earth's magnetic field is used as a reference from which a magnetic bearing can be calculated.

The Earth's magnetic field, however, is subject to anomalies caused by metal objects in the geographical area. For example, the metal in an engine may generate a static anomaly that can affect the accuracy of a magnetometer installed in an automobile. Further, buildings, bridges, or the like having metal structures may cause an anomaly in a city or other dynamic environment through which the automobile is traveling.

Before the magnetometer is used for navigation in a dynamic environment subject to anomalies, the magnetometer is calibrated in a static environment. The static environment may comprise, for example, an automobile in which the magnetometer is installed. One exemplary method for calibrating a magnetometer is described in U.S. nonprovisional patent application Ser. No. 11/356,271, filed Feb. 15, 2006 and entitled, “Systems, Methods and Apparatuses for Continuous In-Vehicle and Pedestrian Navigation.” As a result of the calibration, a reference circle having a radius equal to the Earth's magnetic constant is generated. To compensate for static anomalies in the static environment, the calibration further ensures the origin of the reference circle is defined at a (0,0) coordinate of a coordinate system in which the reference circle is generated.

Based on the coordinates corresponding to points on the reference circle, a bearing may be calculated based on a first magnitude of the magnetic field along a first axis of the reference circle and a second magnitude of the magnetic field along a second axis of the magnetic field. However, due to anomalies in a dynamic environment, the measured magnitudes may not correspond to a point on the reference circle. There is, therefore, a need for a correction of the measured coordinates in the dynamic environment.

### SUMMARY

Various embodiments of the invention include a corrected magnetic bearing based on a slope of coordinates of a measured magnetic bearing relative to a defined origin and a magnetic field constant. The correction may be calculated based on a first magnitude of the measured magnetic bearing along a first axis, a second magnitude of the measured magnetic bearing along a second axis, and a magnetic field constant. The corrected magnetic bearing may be represented as a first magnitude of the corrected magnetic bearing along the first axis and a second magnitude of the corrected magnetic bearing along the second axis.

Further embodiments may include a magnetic anomaly variable filter configured to filter high frequency noise from the measured magnetic bearing prior to calculating the corrected magnetic bearing. Other embodiments may comprise a magnetic field anomaly detector configured to compare an anomaly detection limit to a magnitude of the measured and/or filtered magnetic bearing relative to the defined origin.

According to one embodiment, a method comprises receiving from a magnetometer coordinates of a measured magnetic bearing. From the coordinates, a corrected magnetic bearing based on a slope of the coordinates relative to a defined origin and a magnetic field constant is calculated. Lastly, the corrected magnetic bearing is output.

According to another embodiment, a system comprises a magnetic field circle application module configured to receive from a magnetometer a measured magnetic bearing, calculate a corrected magnetic bearing based on the measured magnetic bearing, a defined origin, and a magnetic field constant, and output the corrected magnetic bearing.

According to a third embodiment, a computer readable storage medium has embodied thereon a program, the program being executable by a processor for performing a method for correcting a magnetic bearing. The method comprises receiving from a magnetometer coordinates of a measured magnetic bearing. From the coordinates, a corrected magnetic bearing based on a slope of the coordinates relative to a defined origin and a magnetic field constant is calculated. Lastly, the corrected magnetic bearing is output.

### BRIEF DESCRIPTION OF THE DRAWINGS

FIG. 1 illustrates a plurality of possible measured magnetic bearings relative to the reference circle;

FIG. 2 illustrates the position of a corrected magnetic bearing relative to the measured magnetic bearing and a defined origin;

FIG. 3 is a block diagram of an exemplary magnetometer normalization engine according to various embodiments;

FIG. 4 is a block diagram of a magnetic field circle application module according to various embodiments; and

FIG. 5 is a flow chart of an exemplary process of normalizing the measured magnetic bearing according to various embodiments.

### DETAILED DESCRIPTION

Various embodiments of the invention include systems and methods for correcting a measured magnetic bearing. The measured magnetic bearing may be received from a magnetometer that was previously calibrated within a static environment. Based on the calibration, a reference circle having a defined origin and a radius equal to a magnetic field constant is generated. The measured magnetic bearing should, theoretically, correspond to a point on the reference circle. Due to magnetic field anomalies in a dynamic environment such as a city having a high concentration of metal structures, however, the measured magnetic bearing may not be on the reference circle. The measured magnetic bearing is typically close enough to the reference circle that the slope between the measured magnetic bearing and the defined origin is an accurate indication of an actual magnetic bearing. To correct the measured magnetic bearing, a circle application algorithm may be used to shift the measured magnetic bearing onto the reference circle while preserving the slope.

Further embodiments may include a low pass filter configured to filter out high frequency noise in the measured magnetic bearing prior to calculating the corrected magnetic bearing. Some embodiments may include a magnetic field anomaly detector configured to determine whether an anomaly exists that is sufficiently large enough to introduce uncertainty in the measured magnetic bearing. In these embodiments, a bearing validity indicator may be output based on the determination.

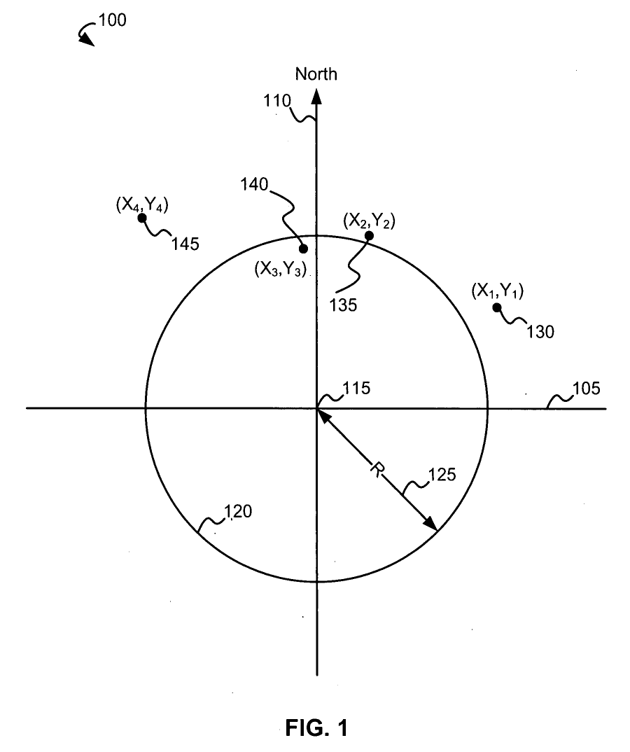

FIG. 1 illustrates a plurality of possible measured magnetic bearings relative to a reference circle in an example 100. The example 100 comprises an x-axis 105, a y-axis 110, a reference circle 120 having a defined origin 115 and a radius 125, and a plurality of possible measured magnetic bearings 130, 135, 140, and 145. The x-axis 105 is an exemplary embodiment of a first axis along which a first magnitude of a measured magnetic bearing may be measured and along which a corrected magnetic bearing may be calculated. As depicted, the x-axis 105 may represent an east-west component of the measured magnetic bearing and the corrected magnetic bearing. The y-axis 110 is an exemplary embodiment of a second axis along which a second magnitude of a measured magnetic bearing may be measured and along which a corrected magnetic bearing may be calculated. As depicted, the y-axis 110 may represent a north-south component of the measured magnetic bearing and the corrected magnetic bearing. The x-axis 105 and the y-axis 110 thus form a coordinate system on which a slope may be measured.

The point of intersection of the x-axis 105 and the y-axis 110 is the defined origin 115. The defined origin 115 may be defined during calibration of the magnetometer to compensate for magnetic field anomalies within a static environment. For example, if the magnetometer is mounted in an automobile, a persistent magnetic field anomaly may be present due to metal structures in the vehicle and/or engine.

Also during calibration, a reference circle 120 about the defined origin 115 is generated. The radius 125 of the reference circle 120 is approximately equal to Earth's magnetic field constant. In an environment having no magnetic anomalies, the measured magnetic bearing will consistently be on the reference circle 120.

The plurality of possible measured magnetic bearings 130, 135, 140, and 145 are received from a magnetometer over a period of time. The plurality of possible measured magnetic bearings 130, 135, 140, and 145 are not on the reference circle 120 due to one or more magnetic anomalies in a dynamic environment. The plurality of possible measured magnetic bearings 130, 135, 140, and 145 are each represented by a set of coordinates (X_{N},Y_{N}) indicating the first magnitude of the measured magnetic bearing along the x-axis 105 and the second magnitude of the measured magnetic bearing along the y-axis 110, respectively. When corrected, the plurality of possible measured magnetic bearings 130, 135, 140, and 145 are shifted to corresponding points on the reference circle 120.

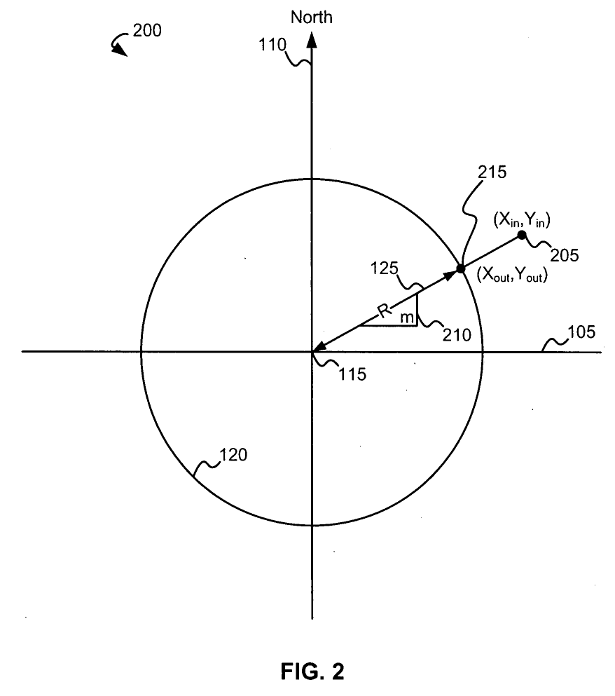

FIG. 2 illustrates the position of a corrected magnetic bearing relative to a measured magnetic bearing and the defined origin 115 in an example 200. The measured magnetic bearing is a set of coordinates measured by the magnetometer in a dynamic environment. The corrected magnetic bearing is a set of coordinates calculated based on the measured magnetic coordinates such that the corrected magnetic bearing is on the reference circle 120. A navigation system may use the corrected magnetic bearing to determine a heading, e.g., north, south, east or west.

A measured magnetic bearing 205 is represented as a set of coordinates (Xᵢₙ,Yᵢₙ). The slope 210 is the slope between the defined origin 115 (i.e., (0,0)) and (Xᵢₙ,Yᵢₙ). A corrected magnetic bearing 215, represented as a set of coordinates (Xₒᵤₜ,Yₒᵤₜ), is calculated such that it is on the reference circle 120. Further, the corrected magnetic bearing 215 has a slope relative to the defined origin 115 that is equal, or nearly equal, to the slope 210. Thus, using a mathematical calculation, the measured magnetic bearing 205 is shifted to a corresponding point on the reference circle 120 while preserving the slope 210.

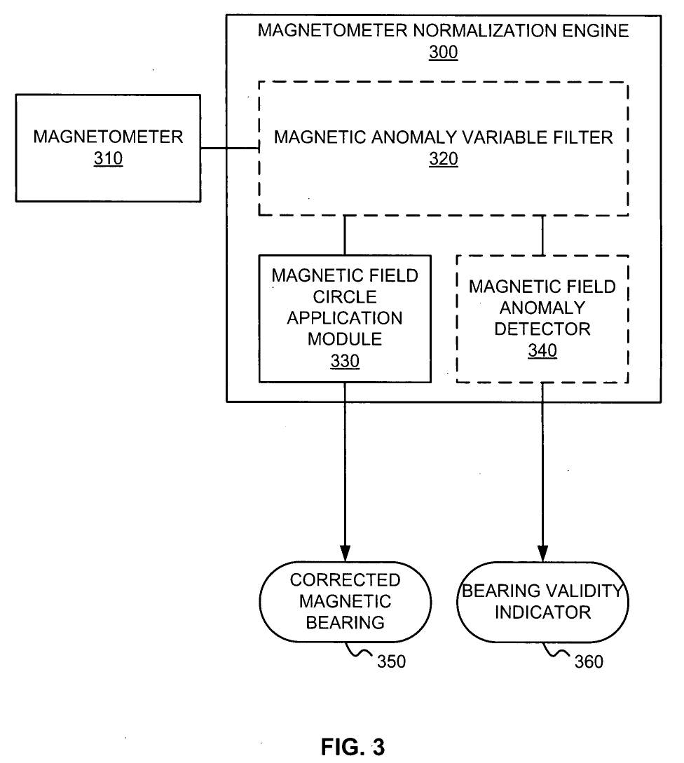

FIG. 3 is a block diagram of an exemplary magnetometer normalization engine 300 according to various embodiments. The magnetometer normalization engine 300 may be connected to, or in electronic communication with, a magnetometer 310. In various embodiments the modules included in the magnetometer normalization engine 300 may be embodied in firmware, hardware, and/or software (stored on a computer readable media) executable by a processor. The magnetometer normalization engine 300 may comprise an optional magnetic anomaly variable filter 320, a magnetic field circle application module 330, and an optional magnetic field anomaly detector 340. If present, the magnetic anomaly variable filter 320 receives a measured magnetic bearing relative to a defined origin from the magnetometer 310. The magnetic field circle application module 330 and the optional magnetic field anomaly detector 340 may receive the filtered measured magnetic bearing from the magnetic anomaly variable filter 320. In other embodiments, the magnetic field circle application module 330 and the optional magnetic field anomaly detector 340 may receive the measured magnetic bearing from the magnetometer 310.

The magnetometer 310 comprises a calibrated magnetometer configured to measure the strength and direction of a magnetic field. The magnetometer 310 may measure the direction of the magnetic field in two or three dimensions. The output of the magnetometer 310 includes a magnitude of the magnetic field in each of the dimensions. For example, if the magnetometer 310 is configured to measure the direction of the magnetic field in two dimensions, the output may be a coordinate such as “(3,2)” where “3” indicates the magnitude of the magnetic field along the x-axis 105 and “2” indicates the magnitude along the y-axis 110.

The optional magnetic anomaly variable filter 320 is a low pass filter configured to filter out high frequency noise in the measured magnetic bearing due to magnetic components in the magnetometer 310 and/or the magnetometer normalization engine 300. In some embodiments, the magnetic anomaly variable filter 320 may comprise one or more Kalman filters. In some embodiments, each magnitude within the measured magnetic bearing may be filtered using a separate Kalman filter.

The magnetic field circle application module 330 is configured to calculate a corrected magnetic bearing based on the measured magnetic bearing. In some embodiments, the measured magnetic bearing may be received from the magnetic anomaly variable filter 320. The corrected magnetic bearing has a same slope as the measured magnetic bearing relative to the defined origin 115. In some embodiments, the magnetic field circle application module 330 may calculate the measured magnetic bearing according to the formula:

$${X}_{out} = \sqrt{\frac{{C}^{2}}{1 + {m}^{2}}} and {Y}_{out} = m * \sqrt{\frac{{C}^{2}}{1 + {m}^{2}}}$$

where Xₒᵤₜ is a first magnitude of the corrected magnetic bearing along a first axis, Yₒᵤₜ is a second magnitude of the corrected magnetic bearing along a second axis, C is the magnetic field constant, and m is the slope calculated according to the formula

$$m = \frac{{Y}_{i n}}{{X}_{i n}}$$

where Xᵢₙ is a first magnitude of the measured magnetic bearing along the first axis and Yᵢₙ is a second magnitude of the measured magnetic bearing along the second axis. In some embodiments, the magnetic field constant, C, is defined as 0.3325 gauss. In other embodiments, C may be determined during calibration of the magnetometer 310 as is known in the art. The output of the magnetic field circle application module 330 is the corrected magnetic bearing 350.

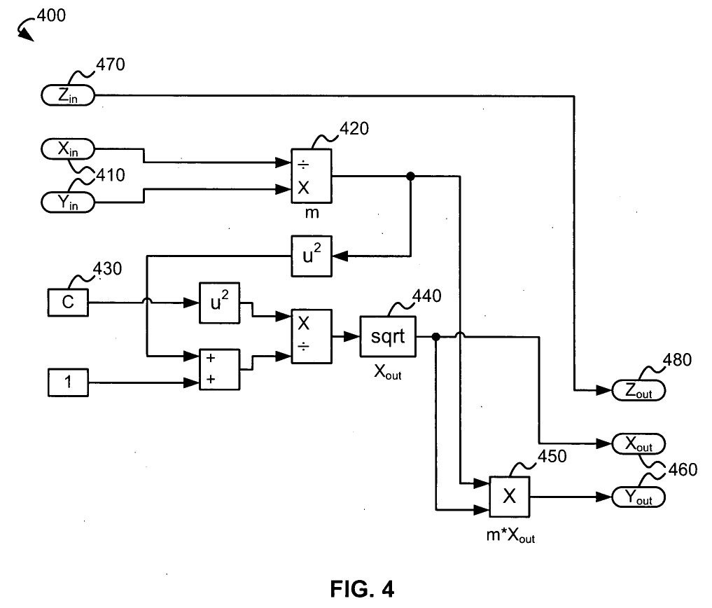

FIG. 4 is a block diagram of a magnetic field circle application module 400 according to various embodiments. The block diagram is a MATLAB® mathematical representation which describes the algorithms and processes that provide the functionality of the magnetic field circle application module 400. It will be appreciated that the mathematical model will represent calculations, processes, and/or methods that may be implemented via any software, hardware, and/or a combination thereof. Thus, it will be appreciated that the magnetic field circle application module 400 illustrated in FIG. 4 is merely an illustrative and non-limiting example of a magnetic field circle application module according to the present invention. As such, it should be appreciated that the present invention may be embodied in alternate forms.

In the embodiment shown, the magnetic field circle application module 400 implements the equations described herein, at least, in connection with the magnetic field circle application 330. A measured magnetic bearing input 410, comprising Xᵢₙ and Yᵢₙ, is used to calculate the slope in a block 420. A magnetic field constant input 430 and the slope are used to calculate Xₒᵤₜ at a block 440. In a block 450, Yₒᵤₜ is calculated using the slope and Xₒᵤₜ. Thus, a corrected magnetic bearing output 460 is output by the magnetic field circle application module 400.

The magnetic field circle application module 400 optionally includes an input and an output representing a third magnitude along a third axis (e.g., Zᵢₙ 470 and Zₒᵤₜ 480). In these embodiments, the measurements along the third axis may be used to compensate for error of the magnetometer as known to those skilled in the art and/or as described, at least, in U.S. nonprovisional patent application Ser. No. 11/356,271 filed Feb. 15, 2006 and entitled, “Systems, Methods and Apparatuses for Continuous In-Vehicle and Pedestrian Navigation.”

Referring back to FIG. 3, the optional magnetic field anomaly detector 340 is configured to detect a severe anomaly in a dynamic magnetic field. The magnitude (e.g., length) of the measured magnetic bearing is proportional to the strength of the dynamic magnetic field. If the dynamic magnetic field is significantly stronger or weaker than the magnetic field constant, a severe magnetic anomaly is likely present. If a severe magnetic anomaly is present, the measured magnetic bearing is not accurate. Thus, the optional magnetic field anomaly detector 340 may calculate a magnitude of the measured magnetic bearing relative to either the defined origin or a mean magnetic field magnitude. The optional magnetic field anomaly detector 340 may then compare the calculated value to one or more anomaly detection limits and output a bearing validity indicator according to a result of the comparison.

In some embodiments, the magnitude of the measured magnetic bearing may be compared to a defined maximum limit and a defined minimum limit. If the magnitude does not exceed the maximum limit and is not below the minimum limit, it is assumed that no severe magnetic anomaly is present.

In other embodiments, the magnetic field circle application module 330 monitors the magnitude of the measured magnetic bearing over a period of time. Based on these values, a mean magnetic field magnitude is calculated. The magnetic field anomaly detector may determine the difference between the measured magnetic bearing and the mean magnetic field magnitude. The difference can then be compared to a defined maximum limit and a defined minimum limit. If the difference does not exceed the maximum limit and is not below the minimum limit, it is determined that no severe magnetic anomaly is present.

Based on the comparison, the magnetic field anomaly detector 340 outputs a bearing validity indicator 360. According to some embodiments, the bearing validity indicator 360 may comprise a single binary bit. If there is a severe magnetic anomaly present, the magnetic field anomaly detector 340 is configured to output a bit corresponding to a “bad” bearing validity indicator. If there is no severe magnetic anomaly present, the magnetic field anomaly detector 340 is configured to output a bit corresponding to a “good” bearing validity indicator.

The bearing validity indicator 360 may be used in a navigation system to determine whether to use the corrected magnetic bearing 350. For example, if a “good” bearing validity indicator 360 is received, the corrected magnetic bearing 350 may be output, displayed to a user, used in further calculations, or the like. In some embodiments, the corrected magnetic bearing 350 may be stored in a memory as a last known good corrected magnetic bearing 350. Otherwise, if a “bad” bearing validity indicator 360 is received, a previously stored last known good corrected magnetic bearing 350 may be retrieved from the memory and output, displayed to a user, used in further calculations, or the like. Using a previously stored last known good corrected magnetic bearing 350 may be referred to as “freezing.”

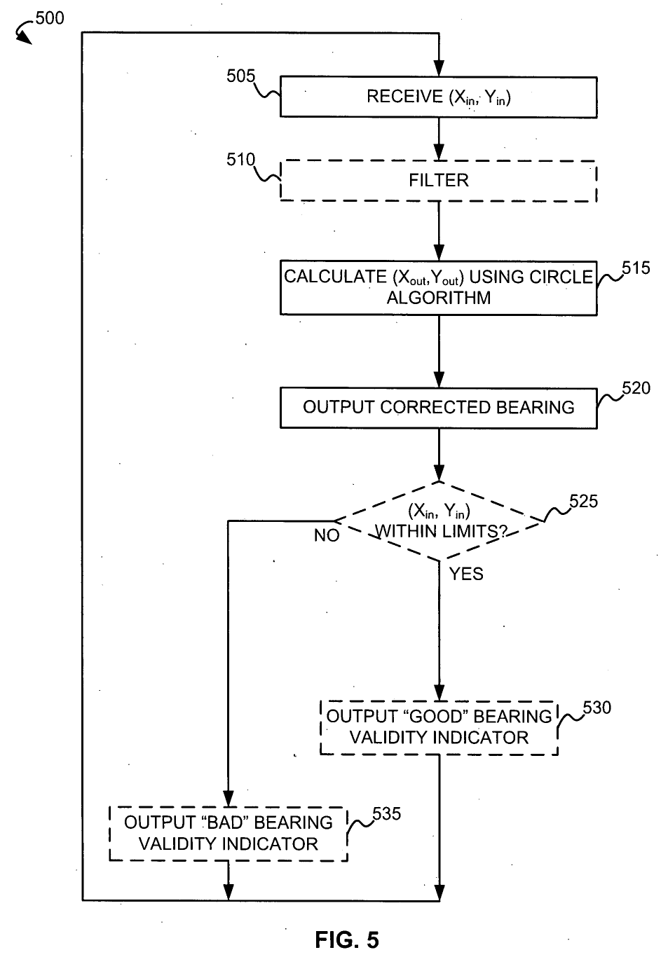

FIG. 5 is a flow chart of an exemplary process of normalizing the measured magnetic bearing according to various embodiments. The method 500 may be performed by the magnetometer normalization engine 300 to calculate the corrected magnetic bearing and, optionally, to determine whether the measured magnetic bearing is valid.

In a step 505, the measured magnetic bearing is received from a magnetometer such as magnetometer 310. The measured magnetic bearing is represented as a set of coordinates (Xᵢₙ,Yᵢₙ) as discussed herein, at least, in connection with FIG. 2.

In an optional step 510, the measured magnetic bearing is filtered to remove high frequency noise and/or disturbances caused by metal components. The measured magnetic bearing may be filtered by the magnetic anomaly variable filter 320.

In a step 515, the corrected magnetic bearing 350 is calculated by the magnetic field circle application module 330. The corrected magnetic bearing 350 is represented as a set of coordinates (Xₒᵤₜ,Yₒᵤₜ) as discussed herein, at least, in connection with FIG. 2.

In a step 520, the corrected magnetic bearing 350 is output. The corrected magnetic bearing may be output to a display or other user interface. Alternatively or additionally, the corrected magnetic bearing may be output to a computing module or engine for further processing.

In an optional step 525, a determination is made by the magnetic field anomaly detector 340 as to whether the measured magnetic bearing is within an anomaly detection limit. In some embodiments, the magnitude of the magnetic field may be compared to the anomaly detection limit in order to determine whether a severe magnetic anomaly exists in the dynamic environment. The anomaly detection limit may be based on a mean magnetic field strength over a period of time.

If the measured magnetic bearing is within the anomaly detection limits, a “good” bearing validity indicator 360 is output in a step 530. If, however, the measured magnetic bearing is not within the anomaly detection limits, a “bad” bearing validity indicator 360 is output in a step 535. For example, the bearing validity indicator may be a designated bit having a value of 0 if the output is “good” and a value of 1 if the output is “bad.”

The bearing validity indicator 360 may be used within a larger navigation system to determine whether to use a previously saved bearing if the magnitude of the measured magnetic bearing relative to the defined origin exceeds the anomaly detection limit. A larger navigation system comprising other navigational aids such as GPS, accelerometers, or the like may use the bearing validity indicator to determine whether to use a last known good bearing, rely on other navigational aids, or the like. For example, in some embodiments, the larger navigation system may be a Destinator Continuous Navigation module as described in U.S. nonprovisional patent application Ser. No. 11/356,271 filed Feb. 15, 2006 and entitled, “Systems, Methods and Apparatuses for Continuous In-Vehicle and Pedestrian Navigation” which is hereby incorporated herein by reference. In these embodiments, if a “bad” bearing validity indicator is received, the navigation system does not update its heading information when a severe magnetic anomaly is detected.

Several embodiments are specially illustrated and/or described herein. However, it will be appreciated that modification and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method comprising:
receiving from a magnetometer coordinates of a measured magnetic bearing;
calculating a corrected magnetic bearing based on a slope of the coordinates relative to a defined origin and a magnetic field constant; and
outputting the corrected magnetic bearing.

2. The method of claim 1, wherein calculating the corrected magnetic bearing is according to the formulas
$${X}_{out} = \sqrt{\frac{{C}^{2}}{1 + {m}^{2}}} and {Y}_{out} = m * \sqrt{\frac{{C}^{2}}{1 + {m}^{2}}}$$
where Xₒᵤₜ is a first magnitude of the corrected magnetic bearing along a first axis, Yₒᵤₜ is a second magnitude of the corrected magnetic bearing along a second axis, C is the magnetic field constant, and m is the slope calculated according to the formula
$$m = \frac{{Y}_{i n}}{{X}_{i n}}$$
where Xᵢₙ is a first magnitude of the measured magnetic bearing along the first axis and Yᵢₙ is a second magnitude of the measured magnetic bearing along the second axis.

3. The method of claim 1, further comprising filtering the received magnetometer coordinates of the measured magnetic bearing before calculating the corrected magnetic bearing.

4. The method of claim 3, wherein the filtering is performed using a Kalman filter.

5. The method of claim 1, further comprising:
comparing an anomaly detection limit to a magnitude of the measured magnetic bearing relative to the defined origin; and
outputting a bearing validity indicator according to the result of the comparison.

6. The method of claim 5, wherein comparing the anomaly detection limit to a magnitude of the measured magnetic bearing further comprises:
calculating a mean magnetic field magnitude; and
determining a difference between the magnitude of the measured magnetic bearing and the mean magnetic field magnitude.

7. The method of claim 5, further comprising:
determining whether to use the corrected magnetic bearing based on the bearing validity indicator; and
using a last known good bearing if the corrected magnetic bearing is not used.

8. The method of claim 5, further comprising:
determining whether to use the corrected magnetic bearing based on the bearing validity indicator; and
using another navigation aid if the corrected magnetic bearing is not used.

9. The method of claim 1, wherein the defined origin and the magnetic field constant are based on a calibration of the magnetometer.

10. A system comprising:
a magnetic field circle application module configured to receive from a magnetometer a measured magnetic bearing, calculate a corrected magnetic bearing based on the measured magnetic bearing, a defined origin, and a magnetic field constant, and output the corrected magnetic bearing.

11. The system of claim 10, wherein the magnetic field circle application module is configured to calculate the corrected magnetic bearing according to the formulas
$${X}_{out} = \sqrt{\frac{{C}^{2}}{1 + {m}^{2}}} and {Y}_{out} = m * \sqrt{\frac{{C}^{2}}{1 + {m}^{2}}}$$
where Xₒᵤₜ is a first magnitude of the corrected magnetic bearing along a first axis, Yₒᵤₜ is a second magnitude of the corrected magnetic bearing along a second axis, C is the magnetic field constant, and m is the slope calculated according to the formula
$$m = \frac{{Y}_{i n}}{{X}_{i n}}$$
where Xᵢₙ is a first magnitude of the measured magnetic bearing along the first axis and Yᵢₙ is a second magnitude of the measured magnetic bearing along the second axis.

12. The system of claim 10, further comprising a magnetic anomaly variable filter configured to filter the measured magnetic bearing and provide the filtered measured magnetic bearing to the magnetic field circle application module, instead of the measured magnetic bearing.

13. The method of claim 12, wherein the magnetic anomaly variable filter comprises a Kalman filter.

14. The system of claim 10, further comprising a magnetic field anomaly detector configured to compare an anomaly detection limit to a magnitude of the measured magnetic bearing relative to the defined origin and output a bearing validity indicator according to the result of the comparison.

15. The system of claim 14, wherein magnetic field anomaly detector is further configured to calculate a mean magnetic field magnitude and determine a difference between the magnitude of the measured magnetic bearing and the mean magnetic field magnitude.

16. The system of claim 10, wherein the defined origin and the magnetic field constant are based on a calibration of the magnetometer.

17. A computer readable storage medium having embodied thereon a program, the program being executable by a processor for performing a method for correcting a magnetic bearing, the method comprising:
receiving from a magnetometer coordinates of a measured magnetic bearing;
calculating a corrected magnetic bearing based on a slope of the coordinates relative to a defined origin and a magnetic field constant; and
outputting the corrected magnetic bearing.

18. The computer readable medium of claim 17, wherein calculating the corrected magnetic bearing is according to the formulas
$${X}_{out} = \sqrt{\frac{{C}^{2}}{1 + {m}^{2}}} and {Y}_{out} = m * \sqrt{\frac{{C}^{2}}{1 + {m}^{2}}}$$
where Xₒᵤₜ is a first magnitude of the corrected magnetic bearing along a first axis, Yₒᵤₜ is a second magnitude of the corrected magnetic bearing along a second axis, C is the magnetic field constant, and m is the slope calculated according to the formula
$$m = \frac{{Y}_{i n}}{{X}_{i n}}$$
where Xᵢₙ is a first magnitude of the measured magnetic bearing along the first axis and Yᵢₙ is a second magnitude of the measured magnetic bearing along the second axis.

19. The computer readable medium of claim 17, wherein the method further comprises filtering the received magnetometer coordinates of the measured magnetic bearing before calculating the corrected magnetic bearing.

20. The computer readable medium of claim 17, wherein the method further comprises:
comparing an anomaly detection limit to a magnitude of the measured magnetic bearing relative to the defined origin; and
outputting a bearing validity indicator according to the result of the comparison.
